(19) United States
(12) Patent Application Publication
(10) Pub. No.: US 2017/0313554 A1
(43) Pub. Date: Nov. 2, 2017

(54) ROPE SYSTEMS AND METHODS FOR USE AS A ROUND SLING

(71) Applicant: Samson Rope Technologies, Ferndale, WA (US)

(72) Inventor: Greg Zoltan Mozsgai, Blaine, WA (US)

(21) Appl. No.: 15/498,180

(22) Filed: Apr. 26, 2017

Related U.S. Application Data
(60) Provisional application No. 62/330,110, filed on Apr. 30, 2016.

(51) Int. Cl. B66C 1/12; D07B 7/16

(52) U.S. Cl. CPC B66C 1/12; D07B 7/165; D07B 7/167

(57) ABSTRACT

A round sling system comprises a bearing structure, a cover, and at least one organizer secured to the cover. The bearing structure is arranged to define a plurality of loop portions and to define at least one bearing structure end portion. The cover defines a cover chamber. The at least one organizer is configured to engage the bearing structure such that the at least one organizer maintains a position of the bearing structure relative to the cover and the at least one organizer maintains a spatial relationship of the loop portions at least within the at least one bearing structure end portion.

### RELATED APPLICATIONS

This application (Attorney's Ref. No. P219181) claims benefit of U.S. Provisional Application Ser. No. 62/330,110 filed Apr. 30, 2016, the contents of which are incorporated herein by reference.

### TECHNICAL FIELD

The present invention relates to rope systems and methods and, more specifically, to rope systems and methods configured to be used as a round sling.

### BACKGROUND

A lifting sling is a structure, typically flexible, that allows a connection to be made between first and second attachment points to allow an item to be displaced or, more typically, lifted. For example, a crane may be connected to a load using a sling to allow the crane to lift the load. In this case, the first attachment point may be a hook on the end of the crane, and the second attachment point may be a hook formed by a cargo net or the like that secures the load for lifting.

Slings typically comprise at least an elongate, flexible body having end fittings connected to or formed at each end. The elongate body may be made of, as examples, fabric webbing, wire rope, chain, steel wire mesh, and/or rope round slings. The present invention is of particular significance when embodied as a rope round sling.

A rope round sling typically comprises a load bearing structure comprising load bearing material. The load bearing material typically takes the form of natural or synthetic fibers. The fibers are typically combined to form yarns, and the yarns are typically combined to form strands and/or other sub-components. The load bearing structure may thus take the form of a conventional rope structure spliced together or otherwise formed in the shape of an endless loop.

The load bearing structure is typically covered by a jacket to protect the load bearing structure from abrasion and/or potentially deleterious effects of the elements. The jacket may take the form of a fabric panel structure that is wrapped around the entire endless loop formed by the load bearing structure and secured in place. Alternatively, the jacket may take the form of a cylindrical fabric tube adapted to cover a central portion of the endless loop such that opposing portions of the endless loop form eyes that extend out of each end of the cylindrical fabric tube.

A rope round sling thus may be configured, with or without a jacket, to form first and second eyes adapted to be connected between the first and second attachment points as generally described above. To use a rope round sling in the context of a crane as described above, the crane hook will be passed through a first eye formed by a first portion of the load bearing structure and the load hook would be passed through a second eye formed by a second portion of the load bearing structure opposing the first portion. When the crane hook is raised, the load bearing structure will be placed in tension such that the load is raised with the crane hook.

The need exists for improved rope round slings that are capable of lifting increased loads for a given weight per length unit of the load bearing material.

### SUMMARY

The present invention may be embodied as a round sling system comprising a bearing structure, a cover, and at least one organizer secured to the cover. The bearing structure is arranged to define a plurality of loop portions and at least one bearing structure end portion. The cover defines a cover chamber. The at least one organizer is configured to engage the bearing structure such that the at least one organizer maintains a position of the bearing structure relative to the cover and the at least one organizer maintains a spatial relationship of the loop portions at least within the at least one bearing structure end portion.

The present invention may also be embodied as a method of forming a round sling comprising the following steps. A bearing structure is arrange to define a plurality of loop portions. At least one organizer is secured to the cover. The at least one organizer is arranged to engage the bearing structure such that the at least one organizer maintains a position of at least a portion of the bearing structure relative to the cover. The cover is arranged to define a cover chamber such that the bearing structure is within the cover chamber and the at least one organizer maintains a spatial relationship of the loop portions at least within at least one bearing structure end portion defined by the bearing structure.

The present invention may also be embodied as a round sling system adapted to engage first and second structural members comprising a bearing structure, a cover, a securing system, first and second pairs of end organizers, and at least one intermediate organizer. The bearing structure is arranged to define a plurality of loop portions, first and second bearing structure end portions, and first and second bearing structure side portions. The cover comprises first and second cover end edge portions and first and second cover side edge portions. The securing system configures the cover to define a cover chamber. The first and second pairs of end organizers and the at least one intermediate organizer are secured to the cover. The first pair of end organizers are located on the cover to engage the bearing structure adjacent to the first bearing structure end portion. The second pair of end organizers are located on the cover to engage the bearing structure adjacent to the second bearing structure end portion. The at least one intermediate organizer engages the bearing structure within at least one of the first and second bearing structure side portions. The first and second pairs of end organizers maintain a spatial relationship of the loop portions within the first and second bearing structure end portions.

### BRIEF DESCRIPTION OF THE DRAWINGS

FIG. 1 is a side elevation view of a first example round sling system of the present invention;

FIG. 2A is a section view taken along lines 2A-2A in FIG. 1;

FIG. 2B is a section view taken along lines 2B-2B in FIG. 1;

FIG. 3A is a somewhat schematic plan view of a portion of a first example cover member and a first example rope structure used as part of the first example round sling system depicted in FIG. 1;

FIG. 3B is a somewhat schematic plan view of a portion of a second example cover member and the first example rope structure that may be used as part of the first example round sling system depicted in FIG. 1;

FIG. 3C is a somewhat schematic plan view of a portion of the first example cover member and a second example rope structure that may be used as part of the first example round sling system depicted in FIG. 1;

FIG. 3D is a somewhat schematic plan view of a portion of the second example cover member and the second example rope structure that may be used as part of the first example round sling system depicted in FIG. 1;

FIGS. 4A and 4B are section views taken along lines 4A-4A and 4B-4B, respectively, in FIG. 3A depicting a first example organizer used as part of the first example round sling system depicted in FIG. 1;

FIGS. 5A and 5B are section views similar to FIGS. 4A and 4B, respectively, depicting the process of forming a second example organizer that may be used as part of the first example round sling system depicted in FIG. 1;

FIGS. 6A and 6B are section views similar to FIGS. 4A and 4B, respectively, depicting the process of forming a third example organizer that may be used as part of the first example round sling system depicted in FIG. 1;

FIG. 7 is a side elevation view of a second example round sling system of the present invention;

FIG. 8A is a section view taken along lines 8A-8A in FIG. 7;

FIG. 8B is a section view taken along lines 8B-8B in FIG. 7; and

FIGS. 9A and 9B are section views depicting the process of forming a fourth example organizer that may be used as part of the second example round sling system depicted in FIG. 7.

### DETAILED DESCRIPTION

A round sling system of the present invention may take a number of different forms, and a number of examples of round sling systems of the present invention and components thereof will be discussed separately below.

### I. First Example Round Sling System

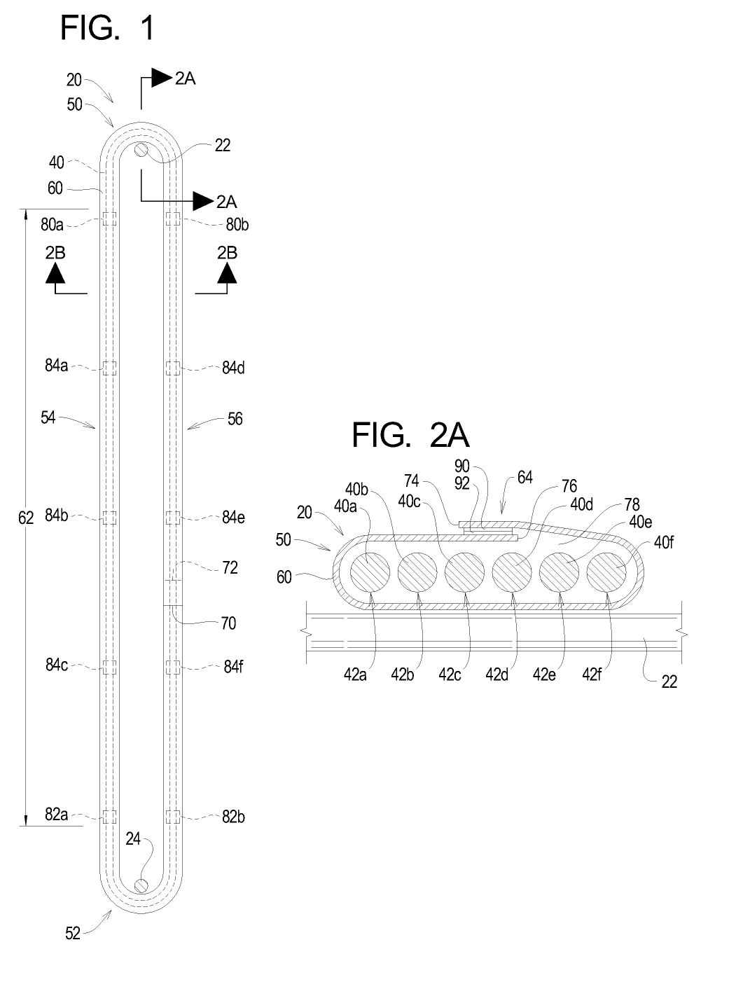

Referring initially to FIGS. 1, 2A, 2B, 3A, 4A, and 4B of the drawing, depicted therein is a first example round sling system 20 constructed in accordance with, and embodying, the principles of the present invention. The first example round sling system 20 is adapted to extend between a first structural member 22 and a second structural member 24 such that, for example, lifting loads applied to the first structural member 22 are transferred through the first example round sling system 20 to the second structural member 24. The term “transfer load” will be used to describe the loads transferred by the first example round sling system 20 between the first and second structural members 22 and 24. The first and second structural members 22 and 24 do not form a part of the present invention and thus will be described herein only to that extent helpful to a complete understanding of the construction and use of the first example round sling system 20.

The first example round sling system 20 comprises a bearing structure 30 and a cover assembly 32.

The example bearing structure 30 comprises one or more lengths of rope configured to bear the anticipated transfer loads applied to the first example round sling system 20. As shown, the example bearing structure 30 comprises a single piece of rope arranged in one or more loops 40 to define a plurality of bearing positions 42. The rope forming the example bearing structure 30 is configured to define six loops 40a, 40b, 40c, 40d, 40e, and 40f arranged in six bearing positions 42a, 42b, 42c, 42d, 42e, and 42f. During use of the first example rope sling 20, the bearing structure 30 defines a first end portion 50, a second end portion 52, a first side portion 54, and a second side portion 56 of the first example rope sling 20 as will be described in further detail below.

The example cover assembly 32 comprises a cover member 60, an organizer system 62, and a closure system 64.

The example cover member 60 is a flat sheet of flexible material such as fabric defining a first end edge 70, a second end edge 72, a first side edge 74, and a second side edge 76. The example cover member 60 is capable of being folded or wrapped into a toroidal shape by overlapping the first and second end edges 70 and 72 and the first and second side edges 74 and 76. When folded with the end edges 70 and 72 overlapped and the side edges 74 and 76 overlapped, the cover member 60 defines a cover chamber 78. The example cover chamber 78 is also substantially toroidal. In use, the substantially toroidal shape of the cover chamber 278 is typically elongated as shown in FIG. 1.

The example organizer system 62 comprises at least one first end organizer 80, at least one second end organizer 82, and, optionally, one or more intermediate organizers 84. The example organizer system 62 comprises a first first end organizer 80a, a second first end organizer 80b, a first second end organizer 82a, and a second second end organizer 82b. The example organizer system 62 further comprises first, second, third, fourth, fifth, and sixth intermediate organizers 84a, 84b, 84c, 84d, 84e, and 84f.

The example closure system 64 comprises a first edge connector 90 and a second edge connector 92.

When the first example round sling system 20 is formed, the bearing structure 30 is arranged within the cover chamber 78, and the bearing structure 30 and the cover assembly 32 are arranged in an elongate loop as shown in FIG. 1. The elongate loop so formed defines the first and second end portions 50 and 52 and the first and second side portions 54 and 56 of the example bearing structure 30 and thus of the first example round sling system 20.

The first end organizers 80 are secured to the cover member 60 such that the first end organizers 80 are adjacent to the first end 50, while the second end organizers 82 are secured to the cover member 60 such that the second end organizers 80 are adjacent to the second end 52. The intermediate organizers 84 are spaced between the first and second end portions 50 and 52 and are secured to the first and second side portions 54 and 56. In the first example round sling system 20, the first and second first end organizers 80a and 80b are arranged at each end of the first end portion 50, while the first and second second end organizers 82a and 82b are arranged at each end of the second end portion 52. Further, in the first example round sling system 20, the first, second, and third intermediate organizers 84a, 84b, and 84c are arranged at evenly spaced locations between the first first end organizer 80a and the first second end organizer 82a along the first side portion 54. Similarly, the fourth, fifth, and sixth intermediate organizers 84d, 84e, and 84f are arranged at evenly spaced locations between the second first end organizer 80b and the second second end organizer 82b along the second side portion 56.

The organizers 80, 82, and 84 are configured to hold the loops defined by the rope forming the bearing structure 20 in the appropriate bearing positions 42 relative to the cover assembly 32. In particular, as perhaps best shown in FIGS. 1, 2B, 3A, 4A, and 4B, the example bearing positions 42 are arranged in a grouping such that the longitudinal axes defining the loop portions 40 of the bearing structure 20 is substantially parallel to and spaced from each other along an organizer axis A at each of the bearing positions 42.

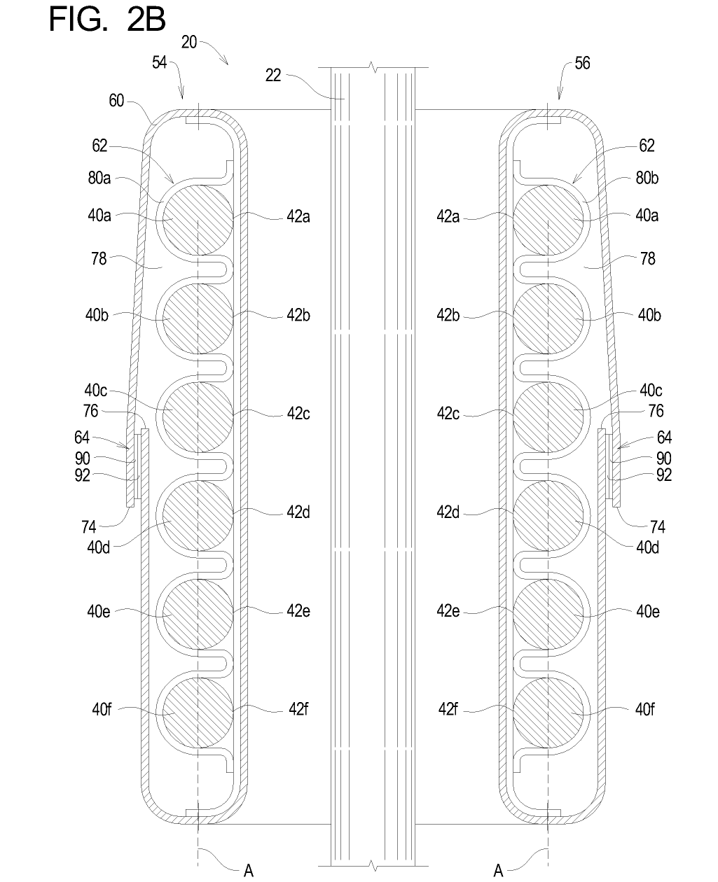

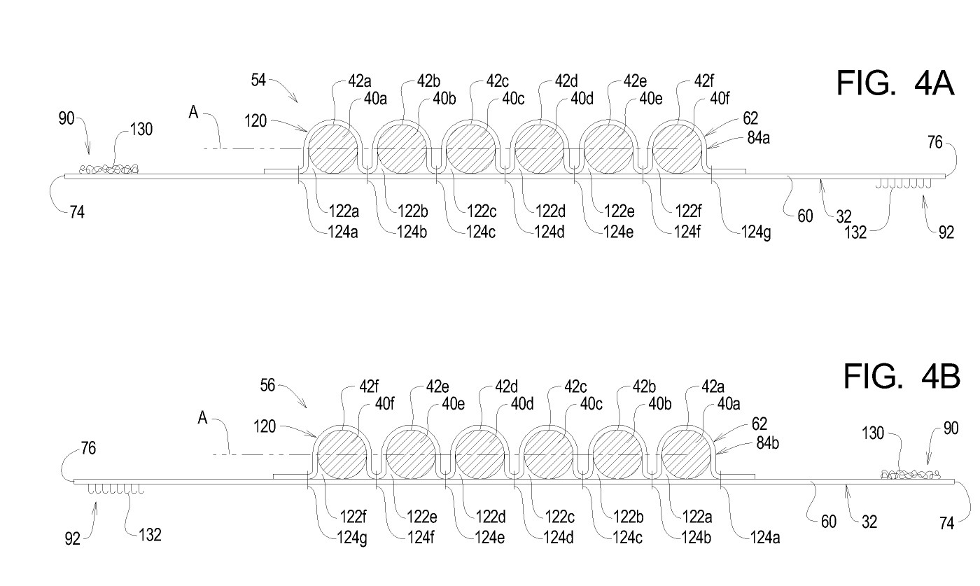

The organizer axes A are depicted as linear FIGS. 2B, 4A, and 4B, but it should be understood that one or more of the organizers 80, 82, and/or 84 may be made of flexible material, in which case the organizer axes A defined thereby can and likely will be curved to define one or more localized points of inflexion along the organizer axis A during normal operation of the first example round sling system 20. However, as will be explained in further detail below, the organizers 80, 82, and 84, and the cover member 60 to which the organizers 80, 82, and 84 are attached, should have sufficient rigidity to prevent the bearing structure 30 from deforming such that the bearing positions 42 do not completely overlap during normal use of first example round sling system 20.

The example closure system 64 secures the first side edge 74 to the second side edge 76 to hold the cover member 60 in a closed configuration to form the cover chamber 78. The example first and second edge connectors 90 and 92 extend along the entire lengths of the side edges 74 and 76, but alternative connector systems may be arranged only at spaced locations along the side edges 74 and 76 as will be described below. A similar connector (not shown) may be arranged to join the first and second end edges 70 and 72, but simply providing sufficient overlap between the first and second end edges 70 and 72 may be effective at holding the cover member 60 in its closed configuration to define the cover chamber 78.

In use, the cover member 60 is held in its closed configuration with the bearing structure 30 within the cover chamber 78. The organizers 80, 82, and 84 are arranged to maintain the bearing structure 30 in a desired relationship with the cover assembly member 60 and also such that the individual loop portions 40 are held within the bearing positions 42. In particular, the first end organizers 80a and 80b are close enough to each other and the second end organizers 82a and 82b are close enough to each other to ensure that longitudinal axes of the loop portions 40 are substantially aligned at the first and second end portions 50 and 52 for desired engagement with the structural members 22 and 24, respectively. If, for example, the first structural member 22 is defined by a linear bar, the organizer axes A of the first and second first organizers 80a and 80b would be substantially linear to ensure that each of the loop portions 40 bears on the linear bar without overlapping another loop portion 40 (see, e.g., 2A). However, if the first structural member 22 is defined by a curved member (e.g., a hook), the organizer axes A of the first and second first organizers 80a and 80b would be sufficiently curved to ensure that each of the loop portions 40 bears on the curved member but without overlapping another loop portion 40.

With the foregoing basic understanding of the first example round sling system 20 in mind, the details of that first example round sling system 20 will now be described.

Referring now to FIGS. 4A and 4B, of the drawing, the example organizers 84a and 84b will be described. The example organizers 80, 82, and 84 all are or may be the same, so the description of the organizers 84a and 84b applies to the other end and intermediate organizers 80, 82, and 84. The example organizers 84a and 84b each comprises an organizer member 120 secured to the cover member 60 to define organizer openings 122. The example organizer members 120 are sewn to the cover member 60 by threads 124. Alternative securing systems and methods such as snap fasteners, adhesives, hook and loop fasteners, or the like may be used to secure the organizer member 120 to the cover member 60.

The example organizer system 62 employs seven threads 124a, 124b, 124c, 124d, 124e, 124f, and 124g to define six of the organizer openings 122a, 122b, 122c, 122d, 122e, and 122f. The six organizer openings 122a, 122b, 122c, 122d, 122e, and 122f correspond to the six example bearing positions 42a, 42b, 42c, 42d, 42e, and 42f, respectively. And the six loop portions 40a, 40b, 40c, 40d, 40e, and 40f are partly arranged within the six organizer openings 122a, 122b, 122c, 122d, 122e, and 122f, respectively.

FIGS. 2A, 2B, 3A, 4A, and 4B illustrate that the example first edge connector 90 is formed by a loop fastener 130 and the example second edge connector 92 is formed by a hook fastener 132. The hook fastener 132 engages loop fastener 130 to secure the first side edge 74 to the second side edge 76 along substantially the entire length of the first and second side edges 74 and 76. Other longitudinal fasteners such as zippers or the like may be used in place of the hook and loop fastener of the example closure system 64.

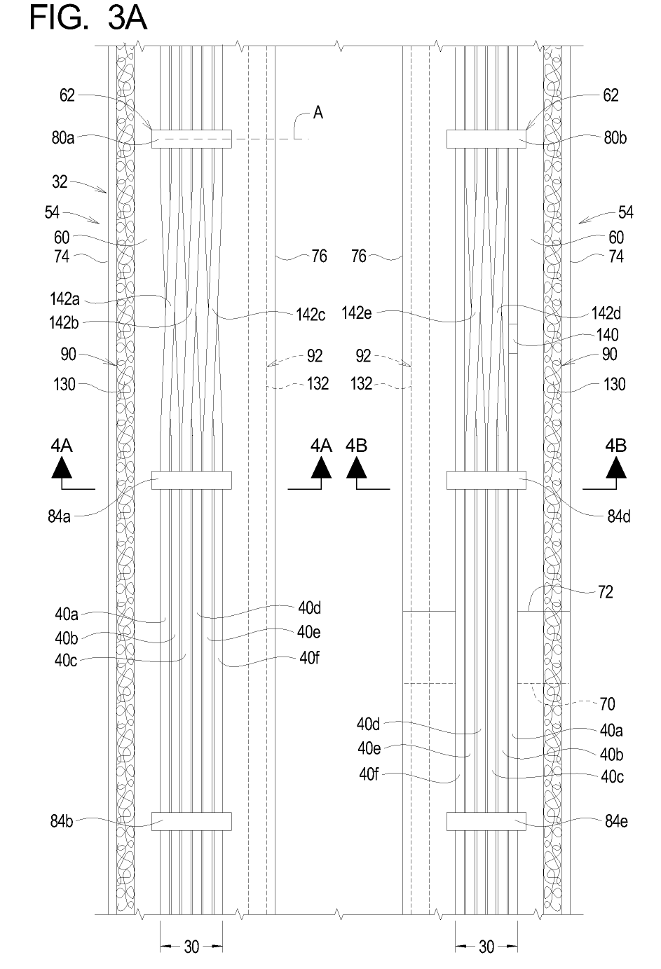

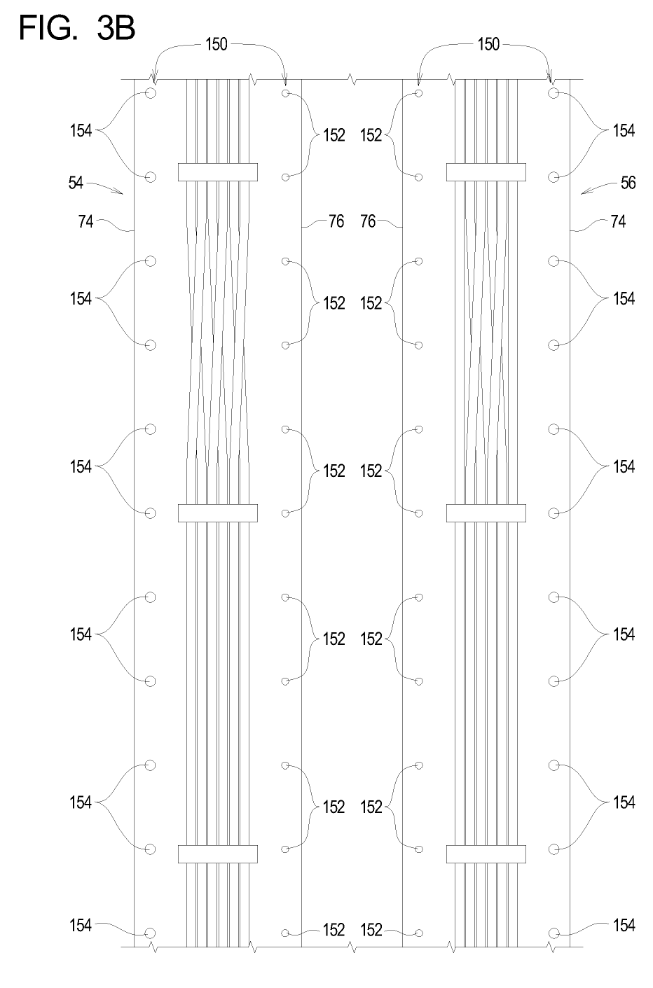

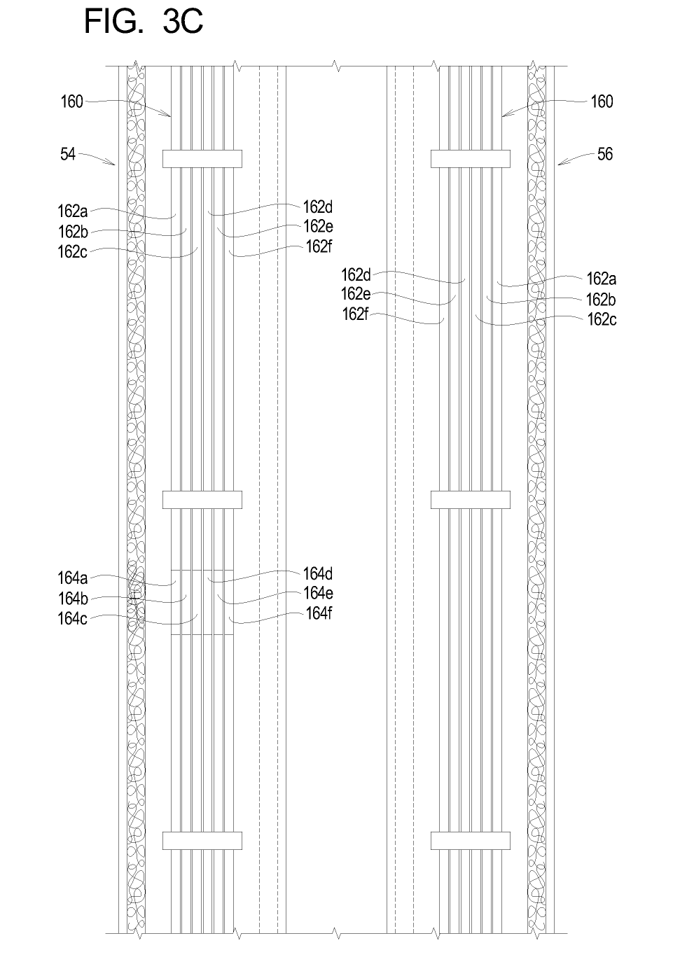

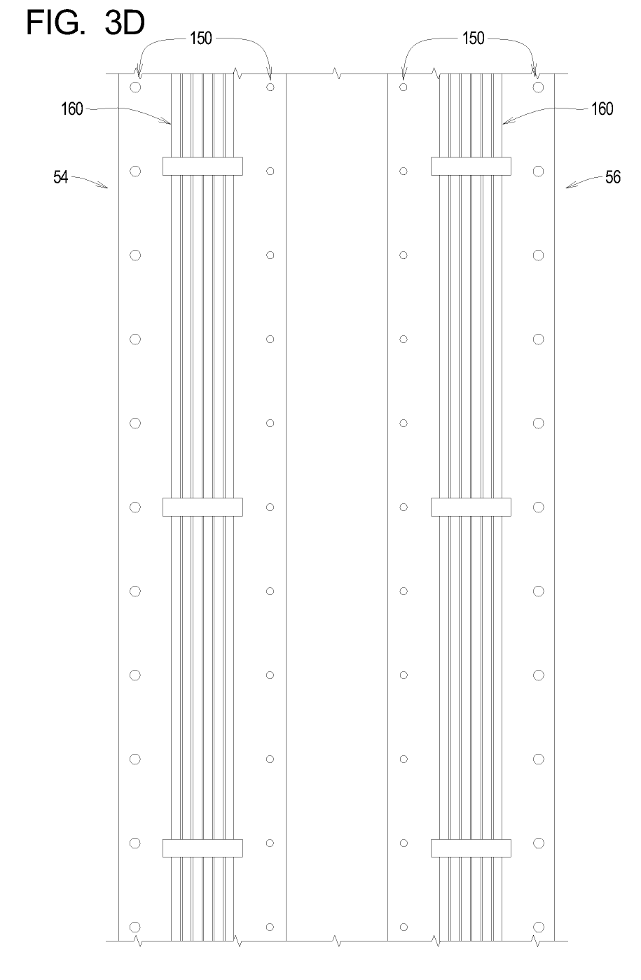

FIG. 3A further illustrates that the example bearing structure 30 is a single length of rope defining a splice region 140. The rope forming the example bearing structure 30 is arranged relative to the cover member 60 such that the example splice region 140 lies in one of the side portions 54 and 56 (in this case the second side portion 56) of the first example round sling system 20 rather than one of the end portions 50 or 52.

In addition, FIG. 3A illustrates that the loop portions 40 formed by the example bearing structure 30 cross at one or more crossing points 142. In particular, the example loop portions 40a, 40b, 40c, 40d, 40e, and 40f cross at first, second, third, fourth, and fifth crossing points 142a, 142b, 142c, 142d, and 142e. In particular, the first, second, and third crossing points 142a, 142b, and 142c are within the first side portion 54, while the fourth and fifth crossing points 142d and 142e are within the second side portion 56. Further, the first, second, and third crossing points 142a, 142b, and 142c are between the first first end organizer 80a and the first intermediate organizer 84a, while the fourth and fifth crossing points 142d and 142e are between the second first organizer 80b and the fourth intermediate organizer 84d. This arrangement further allows the loop portion 40a containing the splice region 140 to be straight and not overlap another loop portion 40 and eliminates the crossing of one loop portion 40 over multiple other loop portions 40. And as generally described above, all crossing of any two (or possibly more) loop portions 40 should be within one of the side portions 54 and 56 and not within one of the end portions 50 or 52.

FIG. 3B illustrates a second example closure system 150 comprising a plurality of snap fasteners arranged at spaced locations along the first and second side edges 74 and 76. In particular, the example closure system 150 comprises a plurality of snap buttons 152 each arranged to engage one of a plurality of snap receivers 154. The mechanically engaging the snap buttons 152 with the snap receivers 154, the first and second side edges 74 and 76 are effectively secured together to form the cover chamber 78.

FIG. 3C illustrates a second example bearing structure 160 that may be used in place of the example bearing structure 30 formed by a single piece of looped rope. The second example bearing structure 160 comprises first, second, third, fourth, fifth, and sixth ropes 162a, 162b, 162c, 162d, 162e, and 162f defining first, second, third, fourth, fifth, and sixth splice regions 164a, 164b, 164c, 164d, 164e, and 164f. With each loop portion 40 formed by a single length of rope 162, crossing of loop portions 40 is eliminated.

FIG. 3D illustrates that the second example closure system 150 may be combined with the second example bearing structure 160.

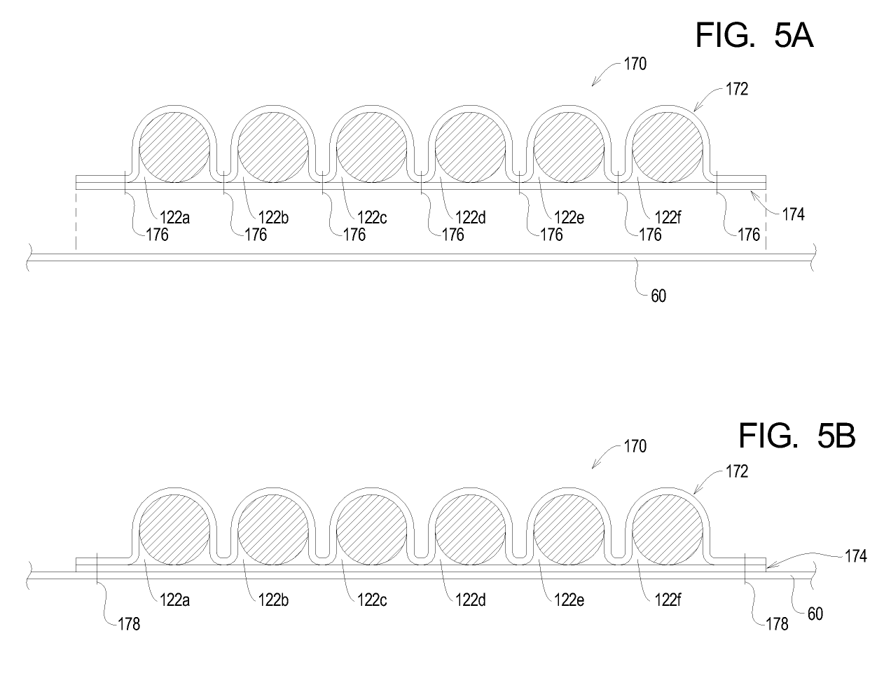

Referring now to FIGS. 5A and 5B of the drawing, depicted therein is a second organizer type 170 that may be used as one or more of the example organizers 80, 82, and 84. The second organizer type 170 comprises a first organizer member 172 secured to a second organizer member 174 to define the organizer openings 122. The example first organizer member 172 is sewn to the second organizer member 174 by threads 176, and the second organizer member 174 is sewn to the cover member 60 by threads 178, but other securing systems and methods such as snap fasteners, adhesives, hook and loop fasteners, or the like may be used to secure the first organizer 172 to the second organizer 174 and/or the second organizer member 174 to the cover member 60.

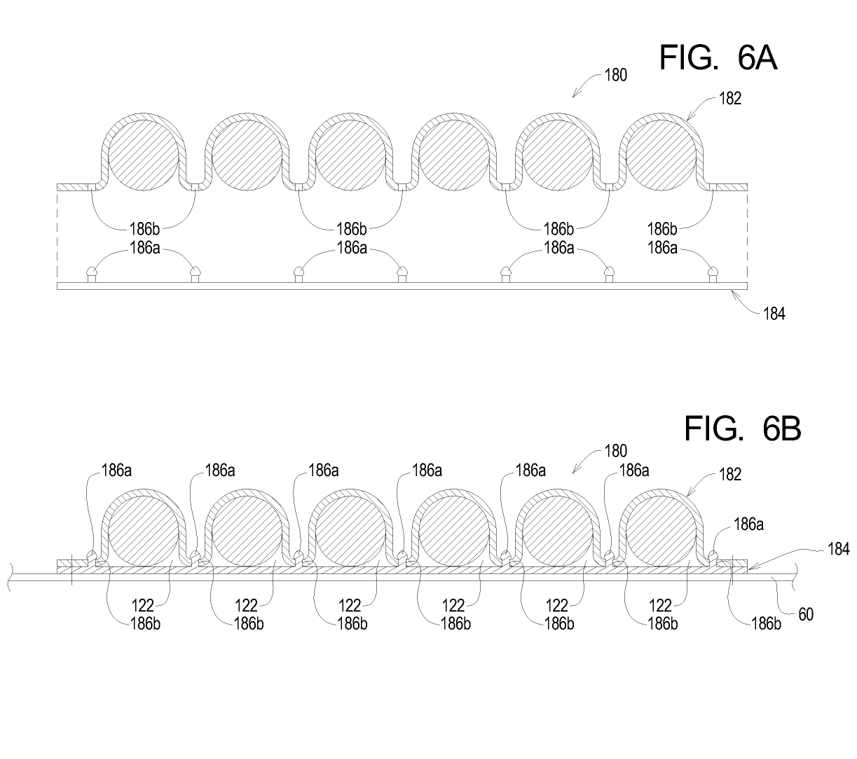

Referring now to FIGS. 6A and 6B of the drawing, depicted therein is a third organizer type 180 that may be used as one or more of the example organizers 80, 82, and 84. The third organizer type 180 comprises a first organizer member 182 secured to a second organizer member 184 to define the organizer openings 122. The example first organizer member 182 is secured to the second organizer member 184 by bayonet members 186a that are received by bayonet openings 186b. The example second organizer member 184 is sewn to the cover member 60 by threads 188. Alternative securing systems and methods such as snap fasteners, adhesives, hook and loop fasteners, or the like may be used to secure the first organizer 182 to the second organizer 184 and/or the second organizer member 184 to the cover member 60.

### II. Second Example Round Sling System

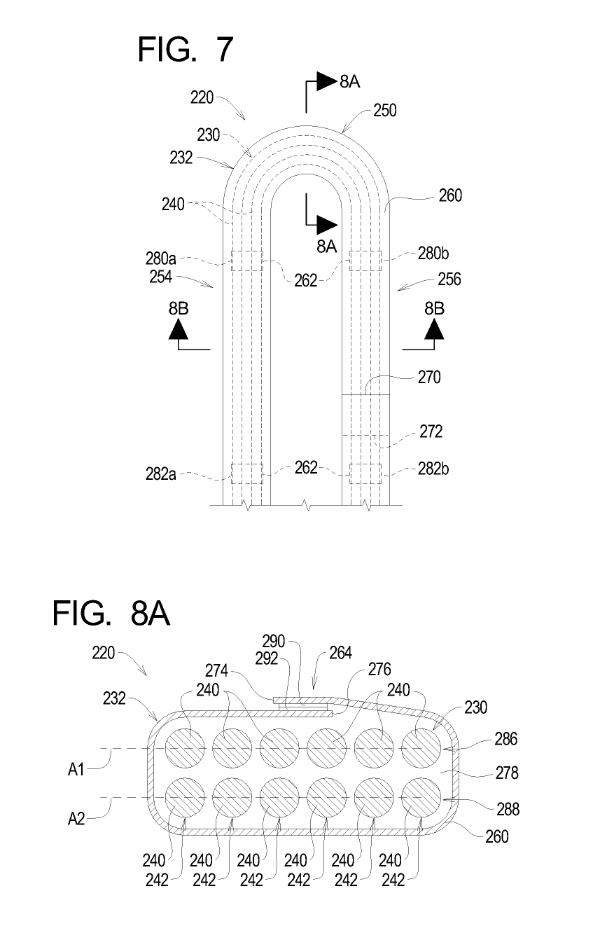

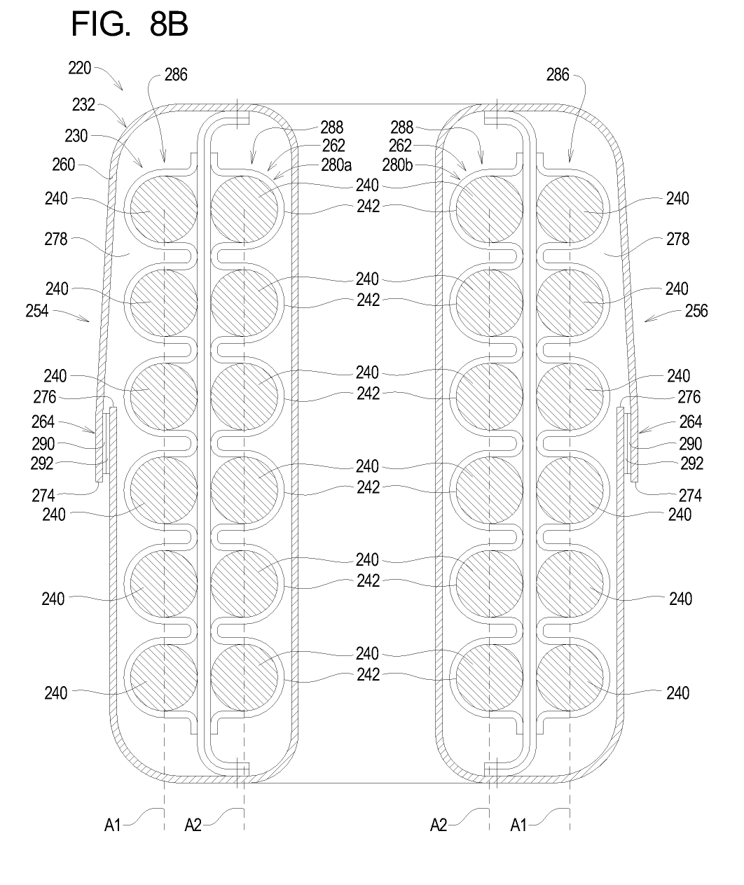

Referring now to FIGS. 7, 8A, and 8B of the drawing, depicted therein is a second example round sling system 220 constructed in accordance with, and embodying, the principles of the present invention. Like the first example round sling system 20, the second example round sling system 220 is adapted to transfer loads between a first structural member (not shown) and a second structural member (not shown).

The second example round sling system 220 comprises a bearing structure 230 and a cover assembly 232.

The example bearing structure 230 comprises one or more lengths of rope configured to bear the anticipated transfer loads applied to the second example round sling system 220. The example bearing structure 230 comprises a single piece of rope arranged in one or more loops 240 to define a plurality of bearing positions 242. The rope forming the example bearing structure 230 is configured to define 12 loops arranged in twelve bearing positions.

During use of the first example rope sling 220, the bearing structure 230 defines a first end portion 250, a second end portion (not visible in FIG. 7), a first side portion 254, and a second side portion 256 of the first example rope sling 220.

The example cover assembly 232 comprises a cover member 260, an organizer system 262, and a closure system 264.

The example cover member 260 is a flat sheet of flexible material such as fabric defining a first end edge 270, a second end edge 272, a first side edge 274, and a second side edge 276. The example cover member 260 is capable of being folded or wrapped into a toroidal shape by overlapping the first and second end edges 270 and 272 and the first and second side edges 274 and 276. When folded with the end edges 270 and 272 overlapped and the side edges 274 and 276 overlapped, the cover member 260 defines a cover chamber 278. The example cover chamber 278 is substantially toroidal. In use, the substantially toroidal shape of the cover chamber 278 is typically elongated as shown in FIG. 1.

The example organizer system 262 comprises at least one first end organizer 280, at least one second end organizer (not shown), and, optionally, one or more intermediate organizers 282.

The example closure system 264 comprises a first edge connector 290 and a second edge connector 292.

When the second example round sling system 220 is formed, bearing structure 230 is arranged within the cover chamber 278, and the bearing structure 230 and the cover assembly 232 are arranged in an elongate loop as shown in FIG. 1. The elongate loop so formed defines the first end portion 250, the second end portions, and the first and second side portions 254 and 256 of the second example round sling system 220.

The first end organizers 280 are secured to the cover member 260 such that the first end organizers 280 are adjacent to the first end 250, while the second end organizers (not shown) are secured to the cover member 260 such that the second end organizers are adjacent to the second end (not shown). The intermediate organizers 282 are spaced between the first end portion 250 and the second end portion (not shown) and are secured to the first and second side portions 254 and 256. In the second example round sling system 220, the first and second first end organizers 280a and 280b are arranged at each end of the first end portion 250, while first and second second end organizers are arranged at each end of the second end portion. Further, in the second example round sling system 220, the intermediate organizers 282 are arranged at evenly spaced locations along the first and second side portions 254 and 256.

The organizers 280 and 282 are configured to hold the loops defined by the rope forming the bearing structure 220 in the appropriate bearing positions 242 relative to the cover assembly 232. In particular, the example bearing positions 242 are arranged in a grouping such that the longitudinal axes defining six of the loop portions 240 are substantially parallel to and spaced from each other along a first organizer axis A1 and six of the loop portions 240 are substantially parallel to and spaced from each other along a second organizer axis A2. As shown in FIGS. 8A and 8B, the first and second axes A1 and A2 defined by the first end organizers 280a and 280b arrange the loop portions 240 in two stacked groups 286 and 288. The end organizers 280a and 280b maintain these stacked groups 286 and 288 throughout the first end portion 250 to control the transfer of loads from the first structural member to the bearing structure 230.

The organizer axes A1 and A2 are depicted as linear in FIG. 8B, but it should be understood that one or more of the end organizers or intermediate organizers may be made of flexible material, in which case the organizer axes A1 and A2 defined thereby can and likely will be curved to define one or more localized points of inflexion along the organizer axes A1 and A2 during normal operation of the second example round sling system 220. However, as will be explained in further detail below, the end and intermediate organizers 280 and 282, and the cover member 260 to which the organizers 280 and 282 are attached, should have sufficient rigidity to prevent the bearing structure 230 from deforming such that the bearing positions 242 do not completely overlap during normal use of second example round sling system 220.

The example closure system 264 secures the first side edge 274 to the second side edge 276 to hold the cover member 260 in a closed configuration to form the cover chamber 278. The example first and second edge connectors 290 and 292 extend along the entire lengths of the side edges 274 and 276, but alternative connector systems may be arranged only at spaced locations along the side edges 274 and 276 as will be described below. A similar connector (not shown) may be arranged to join the first and second end edges 270 and 272, but simply providing sufficient overlap between the first and second end edges 270 and 272 may effectively hold the cover member 260 in its closed configuration to define the cover chamber 278.

In use, the cover member 260 is held in its closed configuration with the bearing structure 230 within the cover chamber 278. The end and intermediate organizers 280 and 282 are arranged to maintain the bearing structure 230 in a desired relationship with the cover assembly member 260 and also such that the individual loop portions 240 are held within the bearing positions 242.

In particular, the first end organizers 280a and 280b are close enough to each other and the second end organizers (not shown) are close enough to each other to ensure that longitudinal axes of the loop portions 240 are substantially aligned at the first end portion 250 and second end portion (not shown) for desired engagement with the structural members (not shown), respectively.

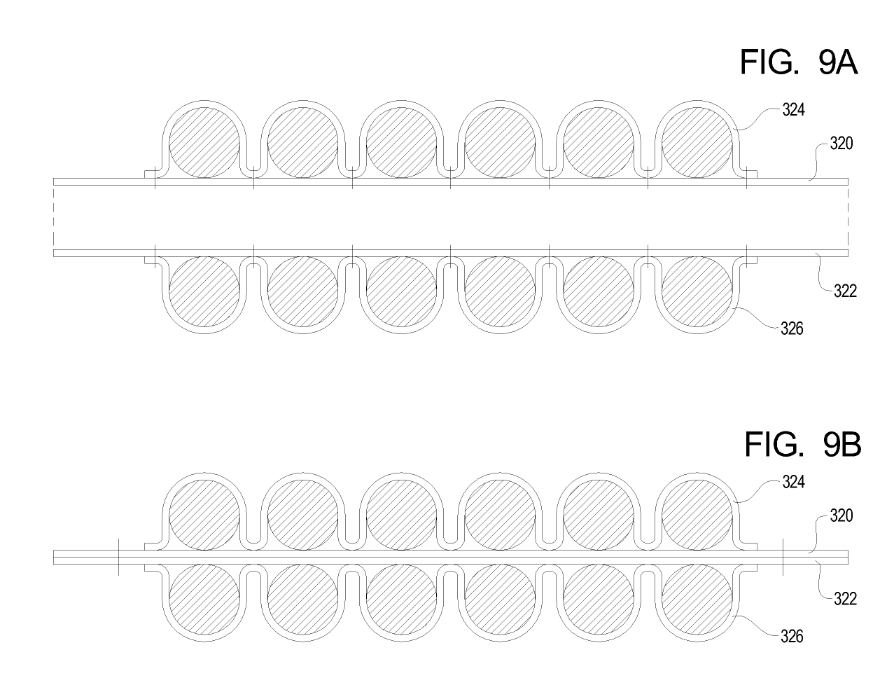

FIGS. 9A and 9B illustrate one example structure of the example organizers 280 and 282 used with the second example round sling system 220. The example organizer structures may be formed by first and second base straps 320 and 322 and first and second loop straps 324 and 326. The first and second loop straps 324 and 226 are sewn to the first and second base straps 320 and 322, respectively. The first and second base straps 320 and 322 are then sewn to the cover member 260. Optionally, the first and second loop straps 324 and 326 may be sewn directly to the cover 260 or to a single base strap that is in turn sewn to the cover. As an alternative to sewing, the loop straps may be secured to the base strap and/or the cover by other securing systems and methods such as hook and loop fasteners, adhesives, snap fasteners, or the like.

### III. Terminology

In this written specification, certain reference characters are used both with a suffix and without a suffix. When a given reference character has been used both with and without a suffix, that given reference character is used without a suffix when referring to that component in general, and the given reference character is used with a suffix to distinguish among multiple similar components in a particular example. In this case, the reference character may be used without a suffix in the specification but will not appear in the drawing without a suffix.

The term “longitudinal” refers to the direction of a reference dimension defined by a dimension of a component that is longer than the dimensions of that component in the two directions orthogonal to the reference direction.

The term “parallel” will be used herein to refer to localized longitudinal directions of two components being compared and does not indicate that the two component are parallel along their entire length.

The term “cross” will be used with reference to a particular perspective to refer to one component overlapping or extending over another component.

What is claimed is:

1. A round sling system, comprising:
a bearing structure arranged to define a plurality of loop portions and to define at least one bearing structure end portion;
a cover defining a cover chamber;
at least one organizer secured to the cover and configured to engage the bearing structure such that
the at least one organizer maintains a position of the bearing structure relative to the cover, and
the at least one organizer maintains a spatial relationship of the loop portions at least within the at least one bearing structure end portion.

2. A round sling system as recited in claim 1, in which:
the bearing structure defines first and second bearing structure end portions; and
at least one organizer is secured to the cover adjacent to each of the first and second bearing structure end portions.

3. A round sling system as recited in claim 1, in which:
the bearing structure defines first and second bearing structure end portions; and
a pair of organizers is secured to the cover adjacent to each of the first and second bearing structure end portions.

4. A round sling system as recited in claim 1, in which:
the cover member defines first and second cover end edge portions; and
the first and second cover end portions overlap at a location spaced from the at least one bearing structure end portion.

5. A round sling system as recited in claim 1, in which:
the cover member defines first and second cover side edge portions and first and second cover end edge portions; and
the first and second cover end portions overlap between the first and second cover end edge portions.

6. A round sling system as recited in claim 5, in which the first and second cover end portions overlap at a location spaced from the at least one bearing structure end portion.

7. A round sling system as recited in claim 1, in which:
the bearing structure defines first and second bearing structure end portions and first and second bearing structure side portions; and
at least one organizer is secured to the cover within each of the first and second bearing structure side portions.

8. A round sling system as recited in claim 2, in which:
the bearing structure further defines first and second bearing structure side portions; and
at least one organizer is secured to the cover with each of the first and second bearing structure side portions.

9. A round sling system as recited in claim 1, further comprising a closure system for securing the cover into a closed configuration.

10. A method of forming a round sling, comprising the steps of:
arranging a bearing structure to define a plurality of loop portions;
providing a cover;
providing at least one organizer;
securing the at least one organizer to the cover;
arranging the at least one organizer to engage the bearing structure such that the at least one organizer maintains a position of at least a portion of the bearing structure relative to the cover;
arranging the cover to define a cover chamber such that
the bearing structure is within the cover chamber, and
the at least one organizer maintains a spatial relationship of the loop portions at least within at least one bearing structure end portion defined by the bearing structure.

11. A method as recited in claim 10, in which:
the bearing structure defines first and second bearing structure end portions when within the cover chamber; and
the step of securing at least one organizer to the cover member comprises the step of securing at least one organizer to the cover adjacent to each of the first and second bearing structure end portions.

12. A method as recited in claim 10, in which:
the bearing structure defines first and second bearing structure end portions when within the cover chamber; and
the step of securing at least one organizer to the cover member comprises the step of securing a pair of organizers to the cover adjacent to each of the first and second bearing structure end portions.

13. A method as recited in claim 10, in which:
the cover member defines first and second cover end edge portions; and
the step of arranging the cover to define a cover chamber comprises the step of overlapping the first and second cover end portions at a location spaced from the at least one bearing structure end portion.

14. A method as recited in claim 10, in which:
the cover member defines first and second cover side edge portions and first and second cover end edge portions; and
the step of arranging the cover to define a cover chamber comprises the step of overlapping the first and second cover end portions between the first and second cover end edge portions.

15. A method as recited in claim 14, in which the step of arranging the cover to define a cover chamber comprises the step of overlapping the first and second cover end portions at a location spaced from the at least one bearing structure end portion.

16. A method as recited in claim 10, in which:
the bearing structure defines first and second bearing structure end portions and first and second bearing structure side portions; and
the step of arranging the at least one organizer to engage the bearing structure comprise the step of securing at least one organizer to the cover within each of the first and second bearing structure side portions.

17. A method as recited in claim 11, in which:
the bearing structure further defines first and second bearing structure side portions; and
the step of arranging the at least one organizer to engage the bearing structure comprise the step of securing at least one organizer to the cover within each of the first and second bearing structure side portions.

18. A method as recited in claim 10, further comprising the step of securing the cover into a closed configuration.

19. A round sling system adapted to engage first and second structural members, comprising:
a bearing structure arranged to define a plurality of loop portions and to define first and second bearing structure end portions and first and second bearing structure side portions;
a cover comprising first and second cover end edge portions and first and second cover side edge portions;
a securing system configuring the cover to define a cover chamber;
a first pair of end organizers secured to the cover;
a second pair of end organizers secured to the cover; and
at least one intermediate organizer secured to the cover; wherein the first pair of end organizers are located on the cover to engage the bearing structure adjacent to the first bearing structure end portion;
the second pair of end organizers are located on the cover to engage the bearing structure adjacent to the second bearing structure end portion;
the at least one intermediate organizer engages the bearing structure within at least one of the first and second bearing structure side portions; and
the first and second pairs of end organizers maintain a spatial relationship of the loop portions within the first and second bearing structure end portions.

20. A round sling system as recited in claim 19, in which:
the cover comprises first and second cover end edge portions and first and second cover side edge portions;
the securing system secures the first and second cover side portions together such that
the first and second side edge portions are not in contact with the first and second structural members, and
the first and second end edge portions overlap adjacent to one of the first and second bearing structure side portions.
